(19) United States
(12) Patent Application Publication
(10) Pub. No.: US 2010/0105275 A1
(43) Pub. Date: Apr. 29, 2010

(54) ORGANIC ELECTROLUMINESCENCE DISPLAY PANEL AND METHOD OF MANUFACTURING THE SAME

(75) Inventor: Hirofumi Kubota, Tsurugashima (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Tokyo (JP)

(21) Appl. No.: 12/529,470

(22) PCT Filed: Mar. 2, 2007
(86) PCT No.: PCT/JP2007/054047

§ 371 Date: Sep. 1, 2009

(51) Int. Cl. H01J 9/00

(52) U.S. Cl. 445/24

(57) ABSTRACT

A method of manufacturing an organic EL display panel, the method includes: a step of forming a first electrode on a substrate; a step of forming an organic functional layer; and a step of forming a second electrode comprising a plurality of stripe-shape electrodes, wherein the step of forming the second electrode includes: a step of pressing a sealing substrate, which has an insulating blade portion protruding toward this substrate, toward the substrate, so that the blade portion mechanically severs a conductive thin film deposited on the organic functional layer, thereby causing separation of adjacent stripe-shape electrodes among the plurality of stripe-shape electrodes, with the blade portion being enclosed therebetween; and a step of fixing the sealing substrate to the substrate.

### TECHNICAL FIELD

This invention relates to an organic electroluminescence (EL) display panel, and to a method of manufacturing such a panel.

### BACKGROUND ART

Organic EL display panels are known as display devices in which are formed, on a substrate, a plurality of organic EL elements, comprising first and second electrodes enclosing a lamination of organic films (hereafter called an “organic functional layer”), comprising a light-emitting layer of an organic compound material exhibiting electroluminescence (hereafter called “EL”), in which light is emitted upon injection of a current.

In a method of manufacturing organic EL display panels, for example, after fabrication in advance of a structure with a reverse-tapered cross-section called a barrier wall on the first electrode of the element substrate on which are formed organic EL elements, the organic functional layer is deposited, and then the second electrode material film is deposited, and through division of the second electrode by the barrier wall, organic EL elements are fabricated (see Patent Document 1).

Further, a method of manufacturing organic EL display panels is also known in which an element panel, comprising a plurality of organic EL elements, and a sealing panel are laminated by pressure-sealing (see Patent Document 2).

Patent Document 2 discloses a display device comprising a sealed panel 20 arranged in opposition to an element panel 10, supporting an organic EL element comprising an organic layer 16 and first and second electrodes 14, 17 enclosing the organic layer 16, as shown in FIG. 1. In the sealed panel 20, spacers 24 are provided on the black matrix 23 of the sealing substrate 21, and conductive protruding portions 24B are formed on the main portions 24A of these spacers 24. The protruding portions 24B comprise, for example, two protrusions. When laminating the element panel 10 and sealing panel 20 by pressure sealing, the protruding portions 24B penetrate the second electrode 17 and the organic layer 16, and as a result the second electrode 17 and the auxiliary wiring layer 18 are electrically connected. By this means, the voltage drop in the second electrode 17 is suppressed, and variation in brightness in peripheral portions and in the center portion of the display screen is reduced.

As shown in FIG. 2, spacers 24, comprising a forked conductive protruding portion 24B and a main portion 24A supporting the protruding portion 24B, are cone-shaped and arranged discretely in a matrix on the sealing substrate 21. Filters corresponding to light-emitting portions are also arranged discretely in a matrix on the sealing substrate 21.

Patent Document 1: Japanese Patent Application Laid-open No. 8-315981

Patent Document 2: Japanese Patent Application Laid-open No. 2005-149800

### DISCLOSURE OF THE INVENTION

### Task to be Solved by the Invention

In technology of the prior art, it is necessary to form structures on the side of the element substrate and on the side of the sealing substrate, and it is difficult to simplify manufacturing processes.

An object of this invention is to provide as examples, an organic EL display panel and manufacturing method for such a panel which simplifies manufacturing processes, and which reduces short-circuit defects between first and second electrodes.

### Means for Solving the Task

A method of manufacturing an organic electroluminescence display panel of this invention comprises:

a step of forming a first electrode on a substrate;

a step of forming an organic functional layer on the first electrode; and,

a step of forming on the organic functional layer a second electrode comprising a plurality of stripe-shape electrodes,

the method being characterized in that the step of formation of the second electrode comprises:

a step of depositing a conductive thin film on the organic functional layer, pressing the sealing substrate, which has an insulating blade portion protruding toward this substrate, toward the conductive thin film, so that the blade portion severs the conductive thin film, thereby causing adjacent stripe-shape electrodes among the plurality of stripe-shape electrodes to be separated, with the blade portion being enclosed therebetween; and

a step of fixing the sealing substrate to the substrate.

An organic EL display panel of this invention has a plurality of organic electroluminescent elements formed on a substrate, and has not only the substrate but also a sealing substrate having blade portions arranged in positions to enclose each the organic EL elements and protruding toward the substrate, each of the blade portions being enclosed between adjacent organic electroluminescent elements among the organic EL elements.

Thus by means of this invention, there is no need for a barrier wall on the element substrate side, a blade portion having a curve conforming to stripes or other arbitrary light emission shapes is formed on the sealing substrate side, and at the time lamination and sealing of the element substrate and the sealing substrate is performed, the second electrode is severed by the blade portion and the blade portion remains, so that defects due to electrode short-circuits can be reduced, and division of the second electrode and sealing can be performed simultaneously, so that manufacturing processes can be simplified.

### BRIEF DESCRIPTION OF THE DRAWINGS

FIG. 1 is a summary partial cross-sectional view of an organic EL display panel of the prior art.

FIG. 2 is a summary partial perspective view of an organic EL display panel of the prior art.

FIG. 3 is a partial enlarged rear view of an organic EL display panel, comprising a plurality of organic EL elements, of an aspect of the invention.

FIG. 4 is a partial cross-sectional view, sectioned along line AA in FIG. 3.

FIG. 5 is a partial cross-sectional view of a substrate in an organic EL display panel manufacturing process of an aspect of the invention.

FIG. 6 is a partial cross-sectional view of a substrate in an organic EL display panel manufacturing process of an aspect of the invention.

FIG. 7 is a partial cross-sectional view of a substrate in an organic EL display panel manufacturing process of an aspect of the invention.

FIG. 8 is a partial cross-sectional view of a substrate in an organic EL display panel manufacturing process of an aspect of the invention.

FIG. 9 is a partial cross-sectional view of a substrate in an organic EL display panel manufacturing process of an aspect of the invention.

FIG. 10 is a partial cross-sectional view of a substrate in an organic EL display panel manufacturing process of an aspect of the invention.

FIG. 11 is a partial cross-sectional view of a substrate in an organic EL display panel manufacturing process of an aspect of the invention.

FIG. 12 is a partial plane view of a sealing substrate, comprising a plurality of blade portions, of an aspect of the invention.

FIG. 13 is a partial cross-sectional view of a substrate in an organic EL display panel manufacturing process of an aspect of the invention.

FIG. 14 is a partial cross-sectional view of a substrate in an organic EL display panel manufacturing process of an aspect of the invention.

FIG. 15 is a partial cross-sectional view of a substrate in an organic EL display panel manufacturing process of an aspect of the invention.

FIG. 16 is a partial cross-sectional view of an organic EL display panel of another aspect of the invention.

FIG. 17 is a partial cross-sectional view of an organic EL display panel of another aspect of the invention.

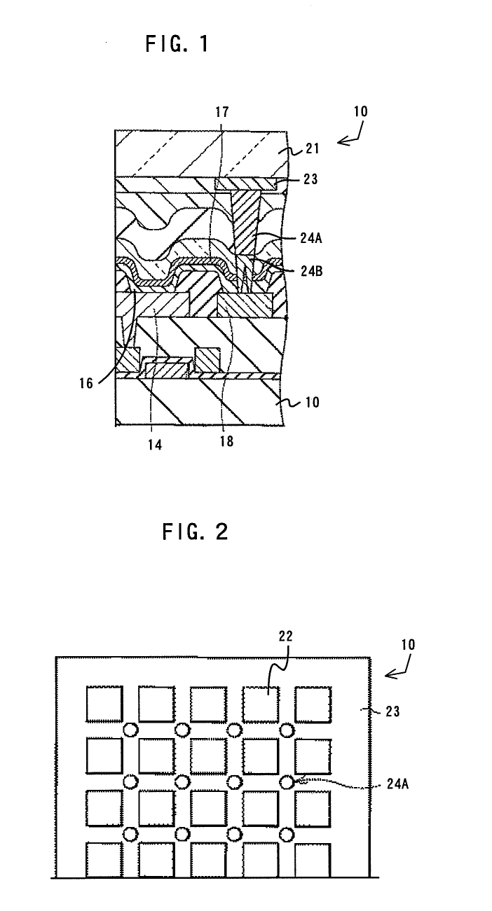

### EXPLANATION OF REFERENCE NUMERALS

10 Substrate
13 First electrode
14 Organic functional layer
15 Second electrode
15a Second electrode material film
19 Wiring electrode
21 Sealing substrate

BL Blade portion
AH Adhesive resin
SP Spacer

### DETAILED DESCRIPTION OF THE INVENTION

Below, organic EL display panels of aspects of the invention are explained, referring to the drawings.

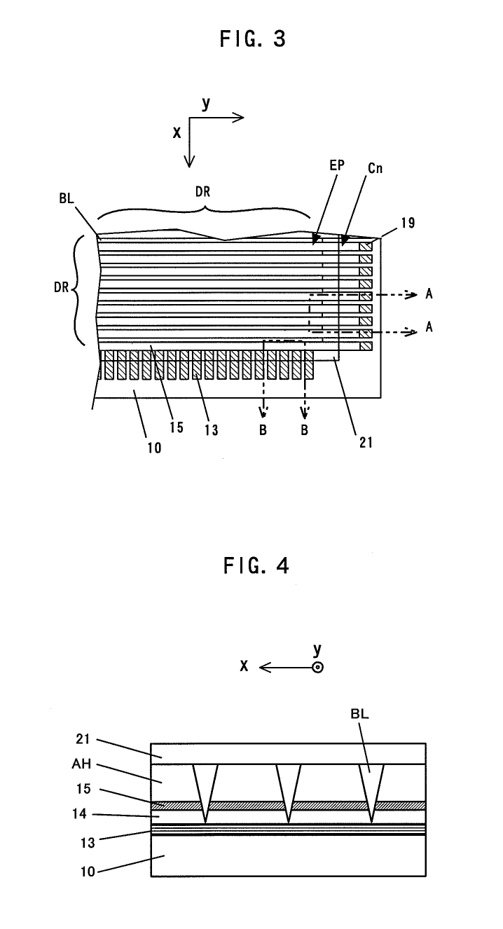

FIG. 3 is a partial enlarged rear view of a passive-driven organic EL display panel, comprising a plurality of organic EL elements, arranged in a matrix on a substrate 10. FIG. 4 is a partial cross-sectional view, sectioning the panel of FIG. 3 along line AA.

This organic EL display panel comprises, layered in order on a substrate 10, a plurality of first electrodes 13, which are row electrodes comprising transparent electrode layers of a conductive material; an organic functional layer 14; and a plurality of second electrodes 15, which are column electrodes comprising metal electrode layers intersecting the row electrodes. The row electrodes are each formed in a stripe shape, and are arranged in parallel at a prescribed equal interval; and similarly for the column electrodes. In this way, the matrix display panel has a display region DR comprising a plurality of organic EL element light-emitting portions EP, formed at the points of intersection of the plurality of rows and columns. The second electrodes 15 are connected via connection portions Cn to wiring electrodes 19. In FIG. 3, the blade portions BL, adhesive resin AH, and blade portions BL are shown as transparent, but this is an example, and the invention is not limited to such a configuration.

As shown in FIG. 4, the sealing substrate 21, onto which blade portions BL of an insulating material are fixed, is laminated from the side of the light-emitting portions EP on the substrate 10, with the adhesive resin AH therebetween. A plurality of blade portions BL are provided in parallel on the sealing substrate 21, at the pitch of the light-emitting portions. That is, adjacent second electrodes 15 on the organic functional layer 14 are arranged with a single blade portion BL enclosed.

In manufacturing processes, a conductive thin film which becomes the second electrodes is deposited onto the substrate 10 and first electrodes 13, and then the plurality of blade portions BL, arranged in parallel, are used in mechanical severing; hence it is desirable that the substrate 10 and the first electrodes 13 both have higher hardness than the blade tips of the blade portions. By this means, at the time of severing by the blade portions, damage or deformation to the substrate 10 and first electrodes 13 is avoided. Also, by severing the conductive thin film by means of the blade portions, the second electrodes 15 are formed, and so it is desirable that a material softer than the blade tips of the blade portions be used. That is, it is desirable that the hardness of the blade portions have a hardness value intermediate between that of the substrate 10 and first electrodes 13, and that of the conductive thin film which becomes the second electrodes.

The hardness of layered film can be measured and compared using the Vickers hardness. In particular, the hardness of a thin film can be determined, similarly to measurements of Vickers hardness, by pressing on the thin film with a diamond indenter, and measuring the indentation depth and load at that time to determine the thin film hardness.

Glass or a resin are generally used in the substrate 10 and sealing substrate 21. For example, alkali-free glass, polycarbonate, or similar is used in the substrate 10. The substrate 10 may comprise transistors or other elements to drive organic EL elements, color filters, color conversion layers, or similar. In the case of a bottom-emission panel, light is extracted to the outside via the substrate 10 and first electrodes 13, and so the substrate 10 and first electrodes 13 are both formed from transparent materials. Although not shown, in the case of a top-emission panel, light is extracted to the outside via the second electrodes 15, and so ITO (indium tin oxide), indium zinc oxide (IZO), or another material with transparency is used in the second electrodes 15.

The first electrodes 13 and second electrodes 15 are anodes or cathodes of organic EL elements. When one is the anode, the other is the cathode. As electrode materials, Al, ITO, IZO, or other known organic EL element anode and cathode materials can be used, and a transparent material is used for electrodes on the side from which light is extracted. In order to manufacture a passive-driven panel, the pattern of both orthogonal electrodes may be stripes, and in order to manufacture an active-driven panel, island shapes associating prescribed patterns with pixels (light-emitting portions) may be used. In the case of an active-matrix driven organic EL display panel, an active circuit, not shown, must also be formed. Specifically, at least two thin film transistors to drive the organic EL display panel, that is, a switching transistor and a driving transistor, must be formed.

The organic functional layer 14 comprising an organic light-emitting layer on the first electrodes 13 may be a single layer, or may comprise a plurality of layers.

When for example the first electrodes 13 and the second electrodes 15 are anodes and cathodes respectively, the organic functional layer 14 comprises a plurality of functional organic material films, layered in order from the first electrodes 13 which are anodes to the second electrodes 15 which are cathodes, and having the respective functions of hole injection layer/hole transport layer/light emission layer/electron transport layer/electron injection layer. And, an electron blocking layer may be provided between the hole transport layer and the light emission layer, and a hole blocking layer may be provided between the light emission layer and the electron transport layer, as functional organic films. Further, except for the light emission layer, any among the hole injection layer, hole transport layer, electron transport layer, electron injection layer, electron blocking layer, and hole blocking layer, may be omitted.

As the material of the organic functional layer 14, a low-molecular-weight dendrimer, polymer, or similar well-known material can be used. For convenience, “organic functional layer 14” is used, but the layer may partially comprise inorganic material.

The organic functional layer 14 can be formed by for example evaporation deposition, sputtering, or another dry process, or by spin coating, an inkjet method, a spray method, or another wet process using an application method.

The wiring electrodes 19 draw the first electrodes 13 and second electrodes 15 to the outside, and can employ well-known wiring materials used in organic EL display panels and LCDs. Elements are connected to an external driving circuit via connection portions Cn between the wiring electrodes 19 and the electrodes. The wiring electrodes 19 are required to have low resistance and environmental stability. As the material of the wiring electrodes 19, for example, single-layer films of Cr, Ti, Al, Al—Nd alloy, Ag alloy, ITO, or similar, as well as films combining layers of these, can be used.

The wiring electrodes 19 may for example be formed by using evaporation deposition or sputtering to deposit a film, and using photolithography to perform patterning. If the pattern is a rough pattern, then a method such as mask evaporation deposition can also be used. Wiring electrodes may also be omitted.

In an organic EL display panel of this aspect, the sealing substrate and blade portions thereof are employed to divide the second electrodes and simultaneously perform sealing, without using barrier walls. In organic EL element manufacturing processes, after full-coverage film deposition of the second electrode material film, the sealing substrate 21, having insulating blade portions BL in predetermined positions, is pressed against the element substrate while laminating with the insulating adhesive resin AH therebetween, the second electrodes are divided by the blade portions BL, and adjacent second electrodes are formed and insulated from each other. By means of the sealing substrate 21 with blade portions BL formed in a parallel pattern, at the time of lamination of the sealing substrate with the element substrate, the second electrodes are divided, and simultaneously the organic EL elements are demarcated.

As described above, an organic EL display panel comprises organic EL elements in a matrix, formed at the positions of intersection of stripe-shape first electrodes 13 and stripe-shape second electrodes 15 orthogonal thereto; adjacent organic EL elements are arranged with a single blade portion BL enclosed therebetween. Thus, in an organic EL display panel of this invention, organic EL elements are adjacent with only blade portions BL enclosed, so that high brightness and high definition organic EL elements can be realized.

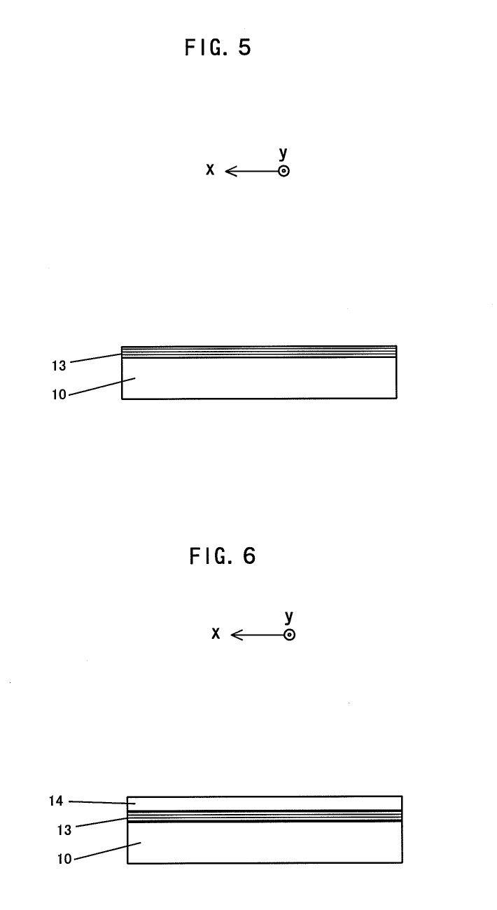

A method of manufacturing an organic EL display panel is explained, using FIG. 5 which shows the cross-section AA in FIG. 3 and other drawings.

First, as shown in FIG. 5, a plurality of first electrodes 13, in the shape of parallel stripes, are formed from a conductive material on the element substrate 10 of the organic EL display panel. Specifically, evaporation deposition, sputtering, or another method is used to deposit conductive material on the substrate 10, and thereafter photolithography is used to perform patterning, to form the first electrodes 13. Although not shown in the figure, where necessary wiring electrodes are formed on the outside of the display region to draw second electrodes to the outside. Wiring electrodes have a prescribed area, in order to secure connection portions demarcated in a subsequent process. Formation of the wiring electrodes may be performed before forming the first electrodes, or the wiring electrodes may be formed simultaneously with the first electrodes using the same material. When the substrate itself is conductive, in place of wiring electrodes, a prescribed area of the substrate surface may be exposed. In these cases of simultaneous formation and of utilization of the substrate, a process to form wiring electrodes is unnecessary.

As shown in FIG. 6, the organic functional layer 14 is formed on the substrate 10 and first electrodes 13. For example, the organic functional layer 14 is formed over substantially the entire surface, in so-called full coverage, of the first electrodes 13, in a region of area greater than the material film for second electrodes 15 in a subsequent process. The organic functional layer 14 may be formed by evaporation deposition. The organic functional layer 14 may be formed using an application method as well; specific application methods include spin coating, blade coating, roll coating, spraying, and other methods of application onto substantially the entire surface of the substrate 10, as well as inkjet methods, flexo-printing methods, dispensing methods, and various other printing methods, or other methods to apply a prescribed pattern. Here, “substantially the entire surface” means that there may be portions in which the film is not formed, such as gap portions between light-emitting portions, and of course also includes cases in which the film is formed completely continuously, without gaps. Individual layers of the organic functional layer 14 may be formed by application for each color of light emitted.

It is preferable that the organic functional layer 14 adequately cover the edges of the first electrodes 13, in order to avoid short-circuits between the first electrodes 13 and second electrodes 15. Specific methods used to form such an organic functional layer 14 may be an evaporation deposition method or application method in which the substrate 10 is rotated. If an application method is used in formation of a portion of the organic functional layer 14, coverage of the edges of the first electrodes 13 is good, and so such a method is preferred.

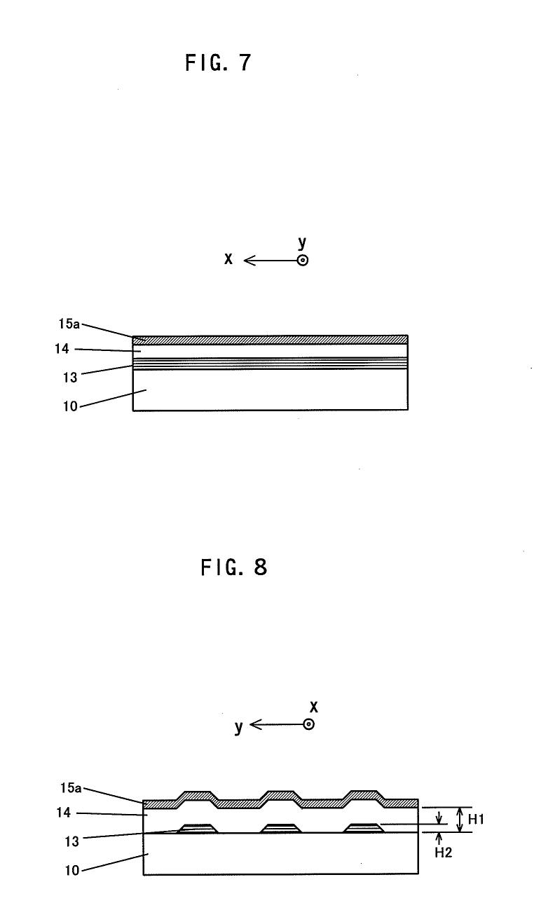

Next, as shown in FIG. 7, the second electrode material film 15a used to form the second electrodes is formed, in full coverage, over a region covering the display region. As shown in FIG. 8 (equivalent to a partial cross-sectional view when sectioning along line BB in FIG. 3), it is desirable that the film be deposited such that the film thickness H1 of the organic functional layer 14 is greater than the film thickness H2 of the first electrodes 13. By this means, the lowermost face of the second electrode material film 15a which becomes the second electrodes is formed at a position which is always higher than the uppermost face of the first electrodes 13. Hence even when the interface between the second electrode material film 15a and the organic functional layer undulates vertically in the severing direction, the second electrode material film 15a can be reliably severed.

If at least one layer of the organic functional layer 14 is formed in at least the severed portion of the second electrode material film 15a which becomes the second electrodes, then the order of layering of the organic functional layer may be interchanged, or one layer need not be deposited. Further, film deposition may be performed by dividing deposition into a plurality of steps. Further, the second electrode material film 15a may be formed by evaporation deposition, sputtering, or similar in regions which at least cover light-emitting regions and, when wiring electrodes are provided, at the connection portions thereof.

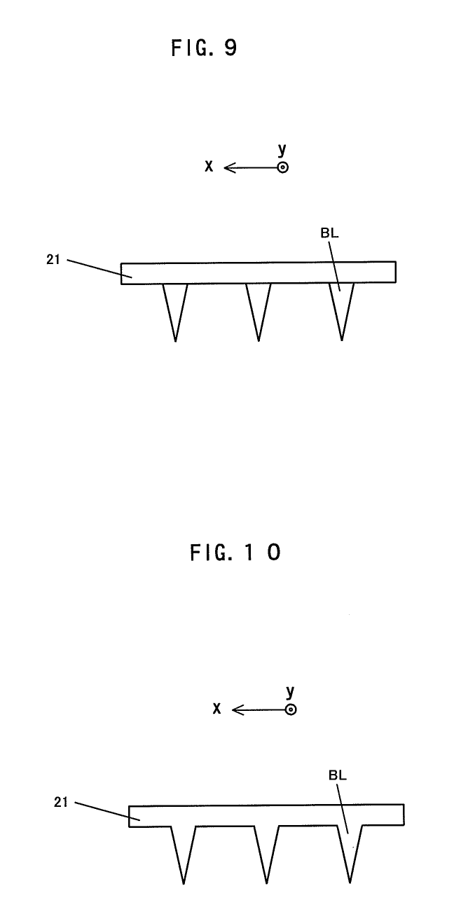

On the other hand, as shown in FIG. 9, a plurality of blade portions BL, comprising an insulating material, are provided, fixed onto the sealing substrate 21 of glass or similar at the prescribed pitch of the light-emitting portions. The blade portions BL have blade tips which are pointed sufficiently to be able to cut the second electrode material film 15a; the blade tips must have a shape directed toward the second electrodes. For example, the blade portions BL are formed such that the blade tips exist in the same plane, or are the same height. The heights of the blade portions BL above the sealing substrate 21 must be at least equal to the film thickness of the adhesive resin AH for sealing+the film thickness of the second electrode material film 15a+50 Å. 50 Å is the extend to which the blade tips of the blade portions BL make contact with the first electrodes 13.

As shown in FIG. 10, the pattern of the blade portions BL may for example be formed integrally with the sealing substrate 21 by performing etching of a glass plate. Or, various film deposition methods may be used to form blade portions BL on the sealing substrate 21. After deposition of a thin film of prescribed film thickness on a glass plate, patterning may then be performed. Or, a glass plate with blade portions BL provided may be formed by injection. Or, pressing may be used to form blade portions BL on a glass plate.

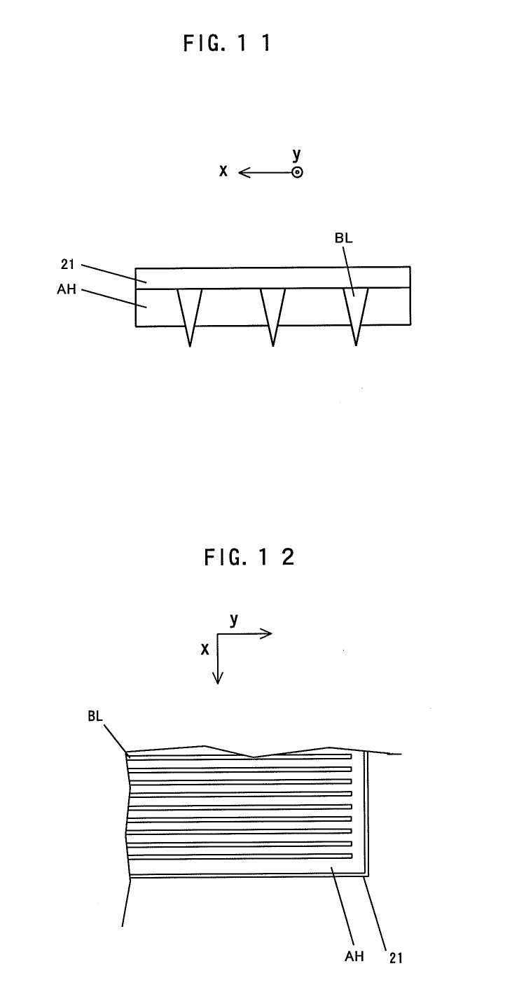

And, as shown in FIG. 11, adhesive resin AH comprising an insulating material is packed between all of the adjacent blade portions BL. As the method for forming the adhesive resin AH between adjacent blade portions of the sealing substrate 21, for example, sheet-shape adhesive resin AH may be affixed. Or, a liquid adhesive resin for sealing AH may be applied onto the sealing substrate 21, or a liquid adhesive resin AH may be applied onto the side of the organic EL elements. As a method of affixing sheet-shape adhesive resin AH, the resin may be affixed including the blade portions BL, or may be partially affixed, avoiding the blade portions BL.

As shown in FIG. 12, the end portions of the blade portions BL formed on the sealing substrate 21 are in a range narrower than the adhesive resin for sealing AH. By this means, the end portions of the blade portions BL are buried in the adhesive resin for sealing AH, so that moisture and similar which may migrate from outside to near the blade portions BL and cause degradation of organic EL elements can easily be blocked. This is because if the end portions of the blade portions BL are outside of the adhesive resin for sealing AH, that is, are exposed, then moisture can easily permeate along the blade portions BL.

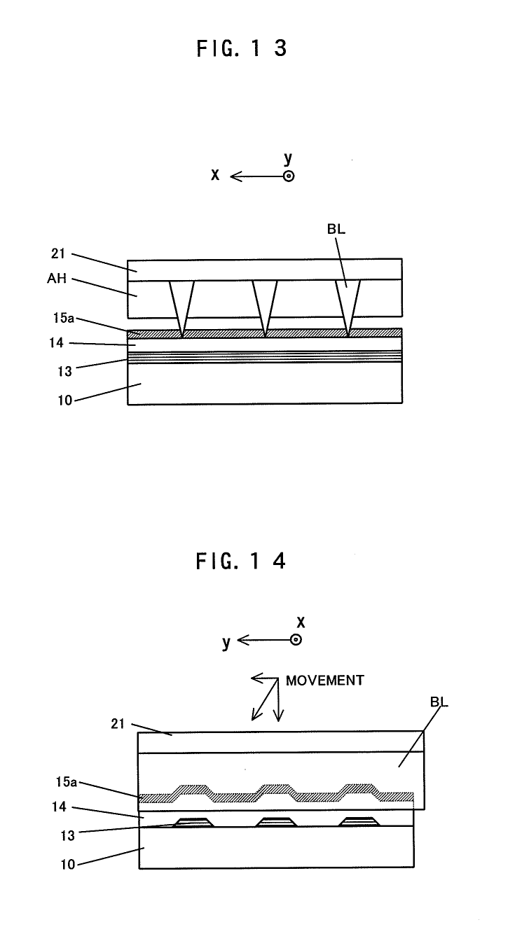

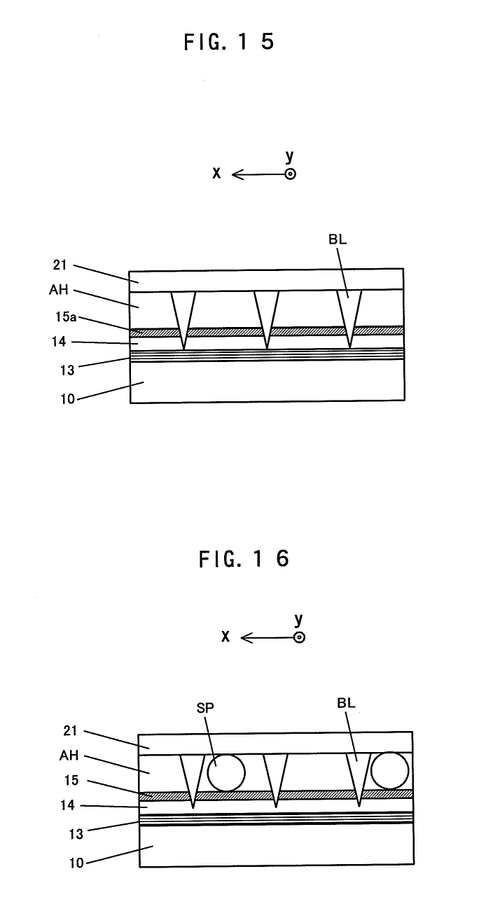

Next, as shown in FIG. 13, the blade portions BL protruding from the sealing substrate 21 are directed toward the substrate 10, and the sealing substrate 21 is pressed to sever the second electrode material film 15a. By mechanically severing the second electrode material film 15a in this way, patterning is performed, and the second electrodes 15 are formed. When severing the second electrode material film 15a, it is preferable that press-cutting be performed, that is, that relative velocity in the direction parallel to the substrate surface of the points of contact of the blade tips of the blade portions BL with the second electrode material film 15a be made zero, and severing be performed while pressing the blade tips against the film; further, it is preferable that severing be performed so as to drag the blade tips of the blade portions BL. That is, as shown in FIG. 14 (equivalent to a partial cross-sectional view when sectioning along line BB in FIG. 3), in order to reliably divide the second electrodes when laminating the two substrates, lamination may be performed while moving the sealing substrate 21, with respect to the substrate 10, in the length direction of the blade portions BL. That is, lamination may be performed while moving the sealing substrate 21 relative to the substrate 10 in the length direction of the blade portions BL (moving in one or both directions), or the substrate 10 may be moved.

As shown in FIG. 15, a structure may be adopted in which, when the element substrate and the sealing substrate 21 are laminated while performing positioning, and the two substrates are made to approach each other until the blade portions BL sever the second electrodes of the organic EL elements, the blade portions BL are pressed against the first electrodes 13, so that the gap between the substrates is held constant, and the second electrodes are divided with stability.

By means of this aspect, there are no structures such as barrier walls or similar on the element substrate side which can readily contain water, so that damage to elements is reduced. Further, because there is no need to form high structures such as barrier walls on the substrate, even polymer materials or other liquid organic EL materials can be applied uniformly. And, because the blade portions BL are in contact with the element substrate, the panel strength can be increased.

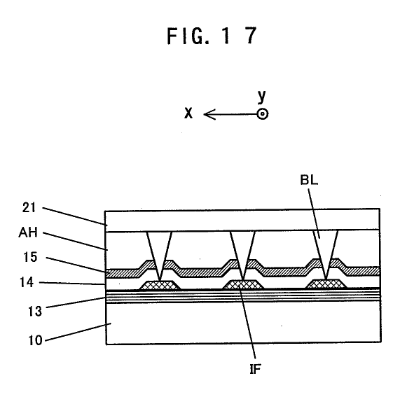

In another aspect, as shown in FIG. 16, particulate spacers SP or similar with a uniform diameter which is smaller than the height of the blade portions BL may be included in the adhesive resin AH. Other than arranging particulate spacers SP in the adhesive resin AH on the substrate 10, this aspect is the same as the above-described aspect.

In still another aspect, as shown in FIG. 17, an organic functional layer 14 comprising an organic EL material is deposited on a substrate 10 on which first electrodes 13 and a patterned insulating film IF have been formed. On this, the second electrodes 15 are deposited. Other than the fact that the insulating film IF is arranged at a prescribed interval on the substrate 10, the aspect is the same as that described above. As the positions at which the blade portions BL press in opposition, it is desirable that the positions be on the insulating film IF of the element substrate; but if the organic functional layer 14 is below the second electrodes 15, the second electrodes 15 can be divided. As the insulating film material when the blade portions BL are pressed in opposition, it is desirable that a material softer than the blade portions be used. For example, polyimides, resists, or other polymer materials may be used. Similarly to the above, in order to facilitate severing of second electrodes at the time of substrate lamination, the sealing substrate 21 may be moved somewhat in the same direction as the length direction of the blade portions BL, and then fixed in place.

In all of the aspects, after hardening the adhesive resin AH, a conventional method is used to perform sealing and connection to external circuitry, and in addition panel division is performed as necessary. Thereafter, in order to exclude outside air from the EL elements, sealing using a known method may be performed.

By means of the above steps, manufacture of an organic EL display panel, comprising an organic EL display panel comprising a plurality of organic EL elements arranged in a matrix, is completed.

1. A method of manufacturing an organic electroluminescence display panel, comprising:
a step of forming a first electrode on a substrate;
a step of forming an organic functional layer on said first electrode; and
a step of forming on said organic functional layer a second electrode comprising a plurality of stripe-shape electrodes,
wherein said second electrode formation step comprises:
a step of depositing a conductive thin film on said organic functional layer, pressing a sealing substrate, which has an insulating blade portion protruding toward said substrate, toward said conductive thin film, so that said blade portion severs said conductive thin film, and thereby causing adjacent stripe-shape electrodes among said plurality of stripe-shape electrodes to be separated, with said blade portion being enclosed therebetween; and
a step of fixing said sealing substrate to said substrate.

2. The method of manufacturing an organic electroluminescence display panel according to claim 1, wherein said sealing substrate is moved in the length direction of said blade portion, relative to said substrate, to perform lamination.

3. The method manufacturing an organic electroluminescence display panel according to claim 1, wherein adhesive resin for sealing is provided on said sealing substrate so as to enclose said blade portion, and end portions of said blade portion are buried by the adhesive resin for sealing.

4. The method of manufacturing an organic electroluminescence display panel according to claim 3, wherein said blade portion has a blade tip, which is sufficiently sharp to enable cutting of said second electrodes.

5. The method of manufacturing an organic electroluminescence display panel according to claim 1, wherein an insulating film is provided on said first electrode at a position against which said blade portion is pressed.

6. An organic electroluminescence display panel comprising:
a plurality of organic electroluminescent elements formed on a substrate;
a sealing substrate;
a blade portions formed on the sealing substrate arranged in positions to enclose each of said organic EL elements and protruding toward said substrate,
wherein adjacent organic electroluminescent elements among said organic electroluminescent elements are in contact with said blade portion which is interposed therebetween.

7. The organic electroluminescence display panel according to claim 6, the display panel further comprising an adhesive resin for sealing which is provided between said sealing substrate and said organic electroluminescent element so as to enclose said blade portion, and end portions of said blade portion are buried by said adhesive resin for sealing.

8. The organic electroluminescence display panel according to claim 6, wherein said blade portion has a blade tip, which is sufficiently sharp to enable cutting of electrodes on a side of said sealing substrate of said organic electroluminescent element.

9. The organic electroluminescence display panel according to claim 6, the display panel further comprising an insulating film which is provided on a side of said substrate of said organic electroluminescent element at a position against which said blade portion is pressed.
